(19) United States
(12) Patent Application Publication
(10) Pub. No.: US 2005/0140227 A1
(43) Pub. Date: Jun. 30, 2005

(54) Spindle motor with bearing system

(76) Inventor: Oswald Kuwert, Herbolzheim-Tutschfelden (DE)

Correspondence Address: NORMAN H. ZIVIN;Cooper & Dunham LLP, 1185 Avenue of the Americas, New York, NY, 10036, US

(21) Appl. No.: 11/012,804

(22) Filed: Dec. 14, 2004

(30) Foreign Application Priority Data
Dec. 24, 2003 (DE) 103 61 229.7

(51) Int. Cl. H02K 5/16; H02K 7/08; H02K 7/09

(52) U.S. Cl. 310/90; 360/99.08; 384/112

(57) ABSTRACT

The invention relates to a spindle motor having at least one rotating part that is rotatably supported with respect to at least one stationary part by means of a bearing system, an electromagnetic drive system being provided whose stator arrangement arranged on the stationary part of the motor is separated by a gap from a magnet arrangement on the rotating part. The distinctive feature of the invention is that the gap simultaneously forms the bearing gap of the bearing system.

### BACKGROUND OF THE INVENTION

The invention relates to a spindle motor having a bearing system according to the preamble of patent claim 1.

### PRIOR ART

Conventional types of spindle motors as used, for example, to drive the platters of a hard disk drive have a bearing system including at least one rotating part, such as a shaft, which is rotatably supported with respect to at least one stationary part, such as a bearing sleeve, by means of a roller bearing, a sliding bearing or a hydrodynamic bearing. The actual rotor of the spindle motor is fixed to the rotating part, the shaft for example. The rotor carries parts of the electromagnetic drive system of the motor and the platters of the hard disk drive. In the kind of design and construction described above, the bearing system is an independent unit whose rotating part has to be connected to the rotor. This means that separate bearing components are necessary which require additional space and go to increase costs.

### SUMMARY OF THE INVENTION

The object of the present invention is to create a spindle motor having a bearing system which can be built to a small scale due to a reduction in the number of necessary components and which provides a means of manufacturing very flat, small-scale hard disk drives.

This object has been achieved according to the invention by the characteristics outlined in patent claim 1.

Beneficial embodiments and further preferred characteristics of the invention are revealed in the subordinate patent claims.

According to the invention, the gap that separates the components of the electromagnetic drive system simultaneously forms the bearing gap of the bearing system. Such an integrated rotor/bearing arrangement makes it possible to manufacture very small spindle motors and consequently to manufacture small-scale hard disk drives as well. It is advantageous if the bearing system takes the form of a hydrodynamic bearing system.

According to a preferred embodiment of the invention, the rotating part of the bearing system is formed by a rotor which carries the magnet arrangement of the drive system. The stationary part of the bearing system is formed by a stator base on which the stator arrangement of the electromagnetic drive system is arranged. This consequently supersedes a bearing system made up of separate components, formed until now, for example, from a shaft rotatably supported in a stationary bearing sleeve.

For assembly purposes, the stator base is formed as a single integral piece but can include a removable cover plate, the rotor being arranged between the stator base and the cover plate. A sandwich-type construction is also conceivable in which the stator is arranged between the baseplate (stator base) and the cover plate.

The rotating and the stationary part of the preferred hydrodynamic bearing system are spaced apart from each other by the bearing gap, a bearing fluid being filled into the bearing gap. The bearing fluid can be a liquid, e.g. a bearing oil, a magnetic fluid or even a gas, such as air. According to the invention, provision can be made for the rotor and the stator base or the cover plate to form not only a radial bearing, in which both the stator base and the rotor have bearing surfaces located opposite each other and running concentric to the rotational axis, but also an axial bearing, in which the stator base or the cover plate and the rotor include bearing surfaces located opposite each other and running essentially perpendicular to the rotational axis. The bearing surfaces are provided in the conventional way with a surface structure, a groove pattern for example, to generate the hydrodynamic pressure within the bearing gaps. The bearing surfaces could additionally have a friction and/or wear-reducing coating.

The bearing fluid is preferably kept in the bearing gap through the use of capillary seals or magnetic seals. Here, the capillary seals can advantageously form an equalizing volume which continues in extension of the bearing gap between the surfaces of the rotating and of the stationary part and acts as a reservoir for the bearing fluid.

Depending on the intended application of the spindle motor, according to the invention the rotor can either take the form of an inner rotor motor or an outer rotor motor.

### BRIEF DESCRIPTION OF THE DRAWINGS

Two embodiments of the invention are explained in more detail below on the basis of the drawings. Further characteristics, advantages and possible applications of the invention can be derived from the drawings and the following description.

FIG. 1 shows a schematic sectional view through a spindle motor including the bearing system according to the invention in a first embodiment;

FIG. 2 shows a schematic sectional view through a spindle motor including the bearing system according to the invention in a second embodiment.

### DESCRIPTION OF PREFERRED EMBODIMENTS OF THE INVENTION

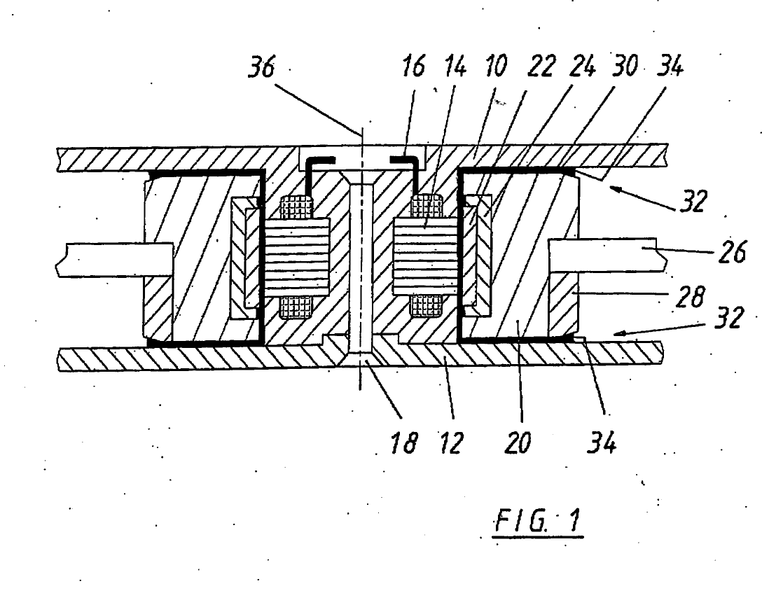

The spindle motor according to FIG. 1 comprises a stator base 10 which has an approximately T-shaped cross-section and is rotationally symmetric with respect to a rotational axis 36. The stator arrangement 14 with the phase windings, which form the stationary part of the electromagnetic drive system of the motor, is located in the central part of the stator base 10. The stator arrangement 14 is supplied with power via electrical connections 16. A cover plate 12 is set on the stator base 10 and is connected to it by some means of fastening 18 such as a central screw.

Between the stator base 10, the cover plate 12 connected to it and the stator arrangement located between the two, there is an annular cavity in which, according to the invention, a likewise annual rotor 20 is arranged. The rotor 20 has an annular slot on its inside diameter in which a preferably annular permanent magnet 22, held in a yoke 24, is arranged. The permanent magnet 22 is spaced slightly apart from and positioned opposite the stator arrangement 14 and forms the rotating part of the electromagnetic drive system of the motor. On its outside diameter, the rotor 20 has an annular recess in which a platter 26 is held and preferably secured by a mounting clamp 28.

According to the invention, the surfaces of the stator base 10, the cover plate 12 and the rotor 20 that face each other form a hydrodynamic bearing system having a bearing gap 30 that keeps those parts of the bearing system rotating with respect to each other separate from one another. The bearing gap 30 is filled in the conventional way with a bearing fluid such as a bearing oil.

On the one hand, the rotor 20 and the stator base 10 form a radial bearing having bearing surfaces located opposite each other and running concentric to the rotational axis 36. On the other hand, the rotor 20 and the stator base 10 or the cover plate 12 form an axial bearing, having bearing surfaces located opposite each other and running essentially perpendicular to the rotational axis 36. To generate hydrodynamic pressure in the bearing gap 30, the bearing surfaces are provided in the conventional way with a surface structure, taking, for example, the form of a groove pattern. The bearing surfaces can additionally have a friction and/or wear reducing coating.

Sealing regions 32 are provided at the ends of the bearing gap 30 which prevent bearing fluid from escaping in the region of the platters 26. In the illustrated embodiment, capillary seals are used. The cross-section of the bearing gap 30 widens at its ends to form an essentially conical shape so that an annular equalizing volume 34 is formed in each case which is partly filled with bearing fluid and acts as a reservoir for the bearing fluid.

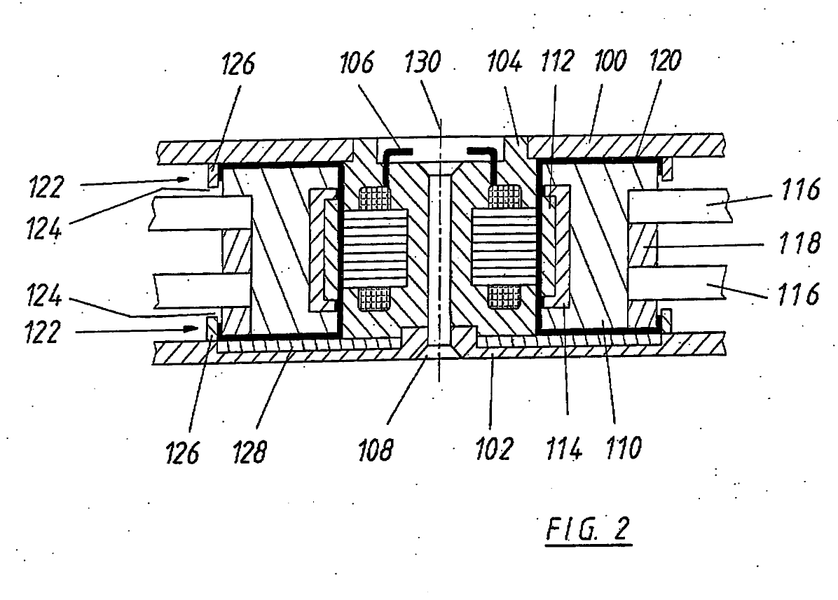

The spindle motor in FIG. 2 is largely identical to the spindle motor illustrated in FIG. 1 and similarly comprises an approximately T-shaped stator base 100. A stator arrangement 104 provided with a plurality of phase windings is provided at the central part of the stator base 100 and goes to form the stationary part of the electromagnetic drive system of the motor. The stator arrangement 104 is supplied with power via electrical connections 106. A cover plate 102 is set on the stator base 100 and connected to it by some means of fastening 108 such as a central screw.

Between the stator base 100, the cover plate 102 and the stator arrangement 104 there is an annular cavity in which, according to the invention, the rotor 110 is arranged. The rotor 110 has an annular slot on its inside diameter in which a preferably annular permanent magnet 112, held in a yoke 114, is arranged. On its outside diameter, the rotor 110 has an annular recess in which a plurality of platters 116 are held and preferably secured by a mounting clamp 118.

According to the invention, the surfaces of the stator base 100, the cover plate 102 and the rotor 110 that face each other form a hydrodynamic bearing system having a bearing gap 120 that keeps those parts of the bearing system rotating with respect to each other separate from one another. The bearing gap 120 is filled in the conventional way with a bearing fluid such as a bearing oil.

In contrast to FIG. 1, the cover plate 102 does not directly form one of the stationary bearing surfaces, but rather an annular counter bearing 128 is set into the cover plate 102, the annular counter bearing 128 directly abutting the bearing gap 120 and defining a stationary bearing surface.

In the same manner as in FIG. 1, both a radial bearing and an axial bearing are formed from the rotor 110, the cover plate 102 or the counter bearing 128 and the stator base 100 whose bearing gaps run concentric or approximately perpendicular to the rotational axis 130 respectively.

At the ends of the bearing gap 120, sealing regions 122 are provided which take the form of capillary seals. End rings 126 are arranged on the stator base 100 or the cover plate 102, the inner sleeve surfaces of the end rings 126 forming the radially inner boundary of the sealing regions 122. The bearing gap 120 forms two equalizing volumes 124 between the inside diameter of the end rings 126 and the outside diameter of the rotor 110 as part of the sealing arrangement.

The rotor/bearing arrangement according to the invention can be modified in many different ways without departing from the basic idea behind the invention. Thus the rotor 20 or 110 can take the form of an outer rotor motor as illustrated in the drawings, or it can just as well take the form of an inner rotor motor.

Identification Reference List

10 Stator base
12 Cover plate
14 Stator arrangement
16 Electrical connections
18 Means of fastening
20 Rotor
22 Magnet (arrangement)
24 Yoke
26 Platter
28 Mounting clamp (platter)
30 Bearing gap
32 Sealing region
34 Equalizing volume
36 Rotational axis
100 Stator base
102 Cover plate
104 Stator arrangement
106 Electrical connections
108 Means of fastening
110 Rotor
112 Magnet
114 Yoke
116 Platters
118 Mounting clamp (platter)
120 Bearing gap
122 Sealing region
124 Equalizing volume
126 End ring
128 Counter bearing
130 Rotational axis

1. A spindle motor having at least one rotating part that is rotatably supported with respect to at least one stationary part by means of a bearing system, an electromagnetic drive system being provided whose stator arrangement arranged on the stationary part of the motor is separated by a gap from a magnet arrangement on the rotating part, characterized in that
the gap simultaneously forms the bearing gap (30; 120) of the bearing system.

2. A spindle motor according to claim 1, characterized in that the bearing system is a hydrodynamic bearing system.

3. A spindle motor according to claim 1, characterized in that the rotating part of the bearing system is formed by a rotor (20; 110) that carries the magnet arrangement of the drive system.

4. A spindle motor according to claim 1, characterized in that the stationary part is formed by a stator base (10; 100) on which the stator arrangement is arranged.

5. A spindle motor according to claim 3, characterized in that the rotor (20, 110) is arranged between a stator base (10; 100) and a cover plate (12; 102) removably connected to the stator base.

6. A spindle motor according to claim 1, characterized in that a bearing fluid is filled into the bearing gap.

7. A spindle motor according to claim 3, characterized in that the rotor (20; 110) and a stator base (10; 100) form a radial bearing.

8. A spindle motor according to claim 3, characterized in that both a stator base (10; 100) and the rotor (20; 110) form bearing surfaces located opposite each other and running concentric to the rotational axis (36; 130).

9. A spindle motor according to claim 3, characterized in that the rotor (20; 110) and a stator base (10; 100) or a cover plate (12; 102) or a counter bearing (128) form an axial bearing.

10. A spindle motor according to claim 9, characterized in that both the stator base (10; 100) and the cover plate (12; 102) or counter bearing (128) and the rotor (20; 110) form bearing surfaces located opposite each other and running essentially perpendicular to the rotational axis (36; 130).

11. A spindle motor according to claim 1, characterized in that the bearing surfaces are provided with a surface structure to generate hydrodynamic pressure within the bearing gap (30; 120).

12. A spindle motor according to claim 1, characterized in that the bearing surfaces have a friction and/or wear-reducing coating.

13. A spindle motor according to claim 1, characterized in that the ends of the bearing gap (30; 120) are sealed by means of capillary seals.

14. A spindle motor according to claim 1, characterized in that the ends of the bearing gap (30; 120) are sealed by means of magnetic seals.

15. A spindle motor according to claim 13, characterized in that the capillary seals form an equalizing volume (34; 124) which is formed in extension of the bearing gap (30; 120) between the surfaces of the rotating and the stationary part and acts as a reservoir for the bearing fluid.

16. A spindle motor according to claim 3, characterized in that the rotor (20; 110) takes the form of an inner rotor motor or an outer rotor motor.
